(19) United States
(12) Patent Application Publication
(10) Pub. No.: US 2002/0013820 A1
(43) Pub. Date: Jan. 31, 2002

(54) Private performance transmission

(76) Inventor: Evan Stephen Crandall, Basking Ridge, NJ (US)

Correspondence Address: S.H. Dworetsky, AT&T Corp., P.O. Box 4110, Middletown, NJ, 07748, US

(21) Appl. No.: 09/775,657

(22) Filed: Feb. 5, 2001

Related U.S. Application Data
(63) Continuation-in-part of application No. 09/597,428, filed on Jun. 20, 2000.

(51) Int. Cl. G06F 15/16; H04N 7/173

(52) U.S. Cl. 709/208; 709/235; 725/134

(57) ABSTRACT

A user may receive performance information for reproducing a performance, and then re-transmit the performance information to another location, either directly or upon request from the other location. The performance information may be modified by the user prior to re-transmission.

### RELATED APPLICATIONS

This application is a Continuation-In-Part of prior pending application Ser. No. 09/597,428, filed on Jun. 20, 2000.

This application is related to co-pending applications Ser. No. 09/597,127, filed on Jun. 20, 2000; ______, filed on ______; and ______, filed on ______.

### BACKGROUND OF THE INVENTION

1. Field of Invention

This invention relates to private performance transmission.

2. Description of Related Art

Currently, performances are transmitted to users via wireless and/or wired networks, such as by radio or television broadcasts. Due to increased network traffic, better technology is needed to make more efficient use of available network resources.

### SUMMARY OF THE INVENTION

This invention provides pseudo-live performance generator (PLPG) systems and methods that output and transmit performances based on one or more of stored information, locally generated information and received information.

The PLPG receives and buffers broadcasts from public broadcast stations, and provides a user an ability to generate a private transmission (point to point, multicast or broadcast) based on the public broadcast. The PLPG may provide filtering capability to separate the received public broadcast information into its constituent parts, thus allowing the user to manipulate the separated information for generating a new performance. The PLPG may provide features such as add, replace, delete or modify different parts of the received information. In this way, the user may generate a private performance that may be transmitted to an audience (friends, family or the whole world).

The PLPG may also provide a remote communication capability so that functions of the PLPG may be activated from a remote location. The PLPG may provide a channel to receive remote commands wirelessly or via a network through a wired connection such as a telephone line. The combination of the remote command capability and the transmission capability discussed above allows a user to operate the PLPG using only a conventional receiver tuned to a channel used by the PLPG for transmission.

These and other features and advantages of this invention are described in or are apparent from the following detailed description of exemplary embodiments.

### BRIEF DESCRIPTION OF THE DRAWINGS

This invention will be described in detail with reference to the following figures, wherein like numerals represent like elements, and wherein:

FIG. 1 is a diagram of a pseudo-live performance generation/transmission system;

FIG. 2 is an exemplary block diagram of a performance transmitter of FIG. 1;

FIG. 3 is a flowchart of an exemplary method for transmitting a performance;

FIG. 4 is an exemplary block diagram of a performance reproduction device of FIG. 1;

FIG. 5 is an exemplary diagram showing content of a storage device of FIG. 1;

FIGS. 6-8 show exemplary diagrams of command sequences;

FIG. 9 is a flowchart of an exemplary method for receiving and transmitting a performance;

FIG. 10 is a flowchart of an exemplary method for composing a performance;

FIG. 11 is a flowchart of an exemplary method for transmitting a performance; and

FIG. 12 is a flowchart of an exemplary method for processing a performance transmission request.

### DETAILED DESCRIPTION OF PREFERRED EMBODIMENTS

In typical radio or television transmission, a transmitting station transmits a mix of real-time performance, such as local news, weather forecasts and real-time comments by the announcer or disk jockey, for example, and stored information, such as movies, songs, advertisements and/or the like. The transmission of the performance is synchronized with the output of the performance by an output device such as a radio or television set. Depending on a particular programming, the real-time performance may constitute a relatively small portion of the total transmission of the broadcasting station.

If information, such as entire libraries of songs or movies, for example, are stored locally near users, this information can be accessed and reproduced in response to commands received from a transmitting station via a network. Instead of transmitting entire songs or movies, for example, the radio or television station can transmit a command for a user's performance reproduction device to reproduce the song or movie. The user's performance reproduction device, such as an enhanced radio or a television set, may access and reproduce the locally stored song or movie based on received commands. Since the radio or television station need not transmit the entire performance, network traffic can be significantly reduced. Additionally, since information is stored at or near the performance reproduction device and subsequently reproduced, commands and/or other information necessary to generate a performance may be transmitted asynchronously with generation of a performance. The commands and/or other information may be transmitted at speeds faster or slower than the performance. Thus, any available network resources may be used independent of the speed of transmission. Therefore, network resources may be utilized more efficiently.

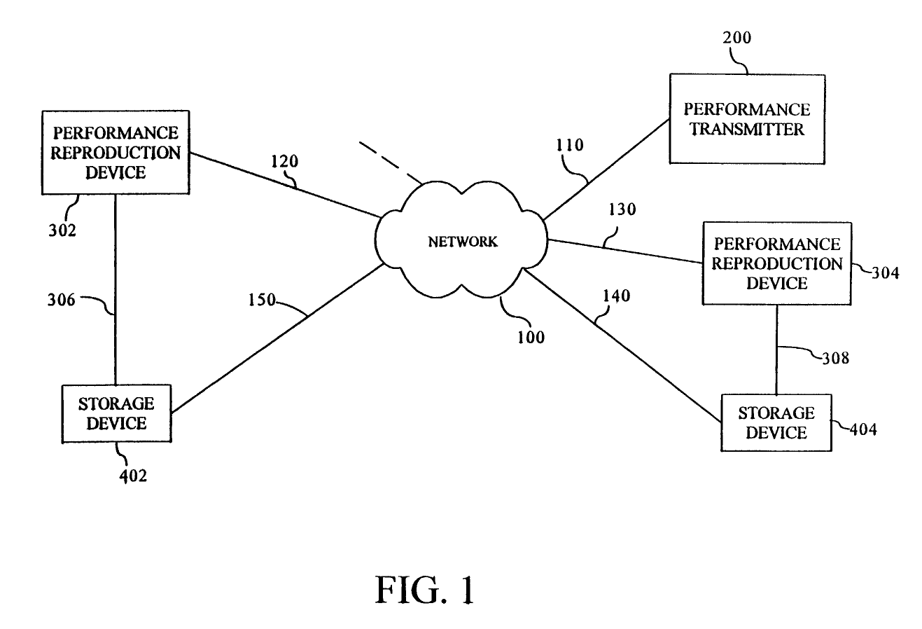

FIG. 1 is a diagram of a network 100 that couples a performance transmitter 200, a performance reproduction device 302, and a performance reproduction device 304. The network 100 may be any type of network or combinations of networks such as a cable network, telephone network, data network, broadcasting network, or the like over any type of medium, such as wired, wireless or optical.

The performance transmitter 200 may be, for example, a radio or television broadcasting station or any other type of performance transmitter adapted to transmit commands to performance reproduction device 302 and/or 304. The performance reproduction devices 302 and 304 are coupled to the network 100 via links 120 and 130, respectively, which may also be either wired, wireless or optical, for example. The performance reproduction devices 302 and 304 may be, for example, enhanced radios or television sets of one or more users.

A storage device 402 is accessible by the performance reproduction device 302 via a wired, wireless or optical link 406, and may be a mass storage device capable of storing a large quantity of information on the order of terabits or more, for example. The storage device 402 may be Read-Only Memory (ROM), erasable ROM, disk, flash, etc. Although shown separately, the storage device 402 and the performance reproduction device 302 may be incorporated within the same physical unit, i.e., as part of the performance reproduction device 302. For example, the storage device 402 may be located within the enhanced radio or television set. If the storage device 402 is provided separately, the performance reproduction device 302 may directly retrieve information from the storage device 402. For example, the performance reproduction device 302 may access the storage device 402 located at a local server of the network 100 that is directly accessible via local connections. In this way, local network resources more dedicated to a smaller number of users are leveraged to conserve network resources that may be utilized by a larger number of users.

Similarly, a storage device 404 may be accessible by the performance reproduction device 304 via a wired, wireless or optical link 408.

The storage devices 402 and 404 may also be independently connected to the network 100 by a links 150 and 140, respectively, which may also be either wired, wireless or optical, for example.

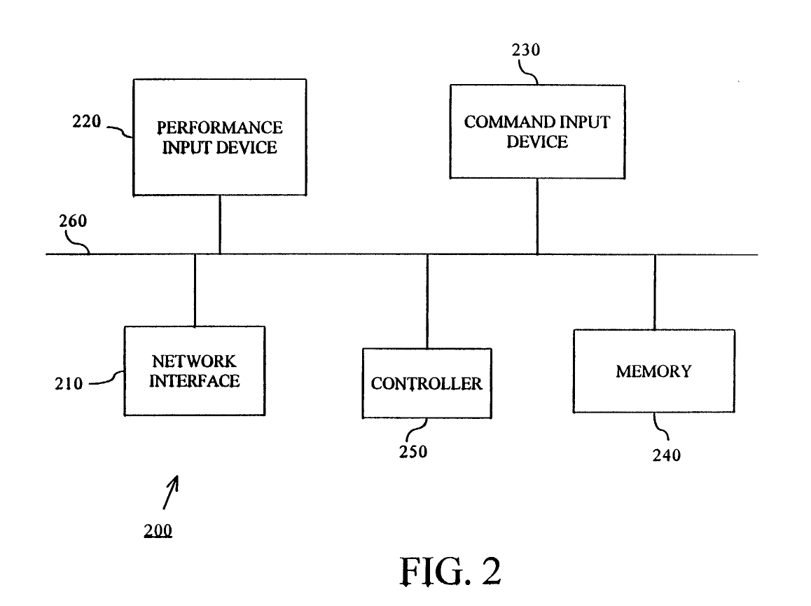

FIG. 2 shows an exemplary block diagram of the performance transmitter 200 of FIG. 1. The performance transmitter 200 may include a network interface 210, a performance input device 220, a mixing command input device 230, a memory 240, and a controller 250, all of which are interconnected by a signal bus 260.

The performance input device 220 receives performance information, such as real-time voice input from a radio announcer or a television news anchor, or receives pre-recorded information such as advertisements or the like. The real-time performance information may be transmitted directly to the network 100 via the network interface 210 or stored in the memory 240 and transmitted at a later time.

The command input device 230 may include one or more input devices (not shown), such as a keyboard, mouse, or one or more manual switches, that enable an operator to input one or more commands. The one or more commands may be transmitted to the network 100 via the network interface 210 or saved in the memory 240 for later transmission as controlled by the controller 250. When received, the commands activate reproduction of performance information for a pseudo-live performance, as described in more detail below.

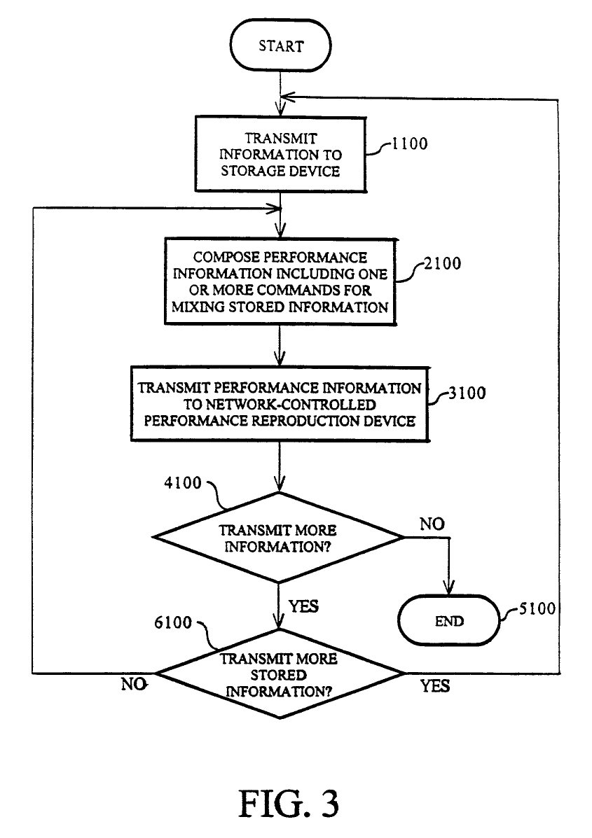

FIG. 3 is a flowchart of an exemplary process for transmitting a performance. In step 1100, the process transmits information such as songs, etc. to be stored in the storage devices 402 and/or 404 via the network interface 210, for example. It should be appreciated that step 1100 may not be necessary because information may have been pre-stored in the storage devices 402 and/or 404. The process then goes to step 2100. In step 2100, the process composes performance information including one or more commands for reproducing a performance based on the stored information. The one or more commands may include performance-oriented commands, housekeeping commands, programming commands, or the like, described in more detail below, and/or may include commands for accessing other commands already stored in the performance reproduction device 302 or 304, as also described in more detail below. The composed performance information may also include real-time performance information and/or stored performance information. The process then goes to step 3100.

In step 3100, the process transmits the performance information to a network-controlled performance reproduction device and goes to step 4100. In step 4100, the process determines whether any more information is to be transmitted. If no more information is to be transmitted, the process goes to step 5100 and ends. If more information is to be transmitted, the process goes to step 6100 and determines whether the information to be transmitted is to be stored in the storage device. If the information to be transmitted is to be stored in the storage device, the process returns to step 1100. If the information to be transmitted is not to be stored in the storage device, i.e., if the information to be transmitted is one or more commands or the like that are to be used immediately or temporarily stored in a buffer separate from the storage device, the process returns to step 2100.

A transmitter may transmit data to the storage device while the performance reproduction device 302 or 304 is reproducing stored information from the storage device 402 or 404. A radio station could transmit one or more commands to activate reproduction of stored information by the enhanced radio, for example; and then while the enhanced radio is reproducing the stored information, such as a song, transmit additional information, such as the following moring's news, for example. Furthermore, since the transmitter is not constrained to transmit synchronously with generation of the performance, the transmitter may transmit at speeds faster or slower than the performance. Thus, “bursting” technology or the like, in which information is transmitted at very high speeds, may be utilized. Further, if it is cost-effective to transmit data at slower-than-performance speeds using less-costly transmitting technology and equipment at off-peak periods of the network, for example, the information may be transmitted at slower-than-performance speeds.

In order to prevent unauthorized access, it may be desirable for the information stored in the storage device 402 or 404, or a portion of the information, to be encrypted such that it can only be read with the aid of a key. The key may be transmitted along with or as part of commands transmitted over the network 100. Alternatively, the key may be sent to a user separately by e-mail, regular mail, or be included with the performance reproduction device 302 or 304 (i.e., installed with the hardware), for example. The keys may be sent upon receipt of monthly payments, for example, or special keys may be sent to the user as a promotional tool for new features already stored in the storage device 402 or 404.

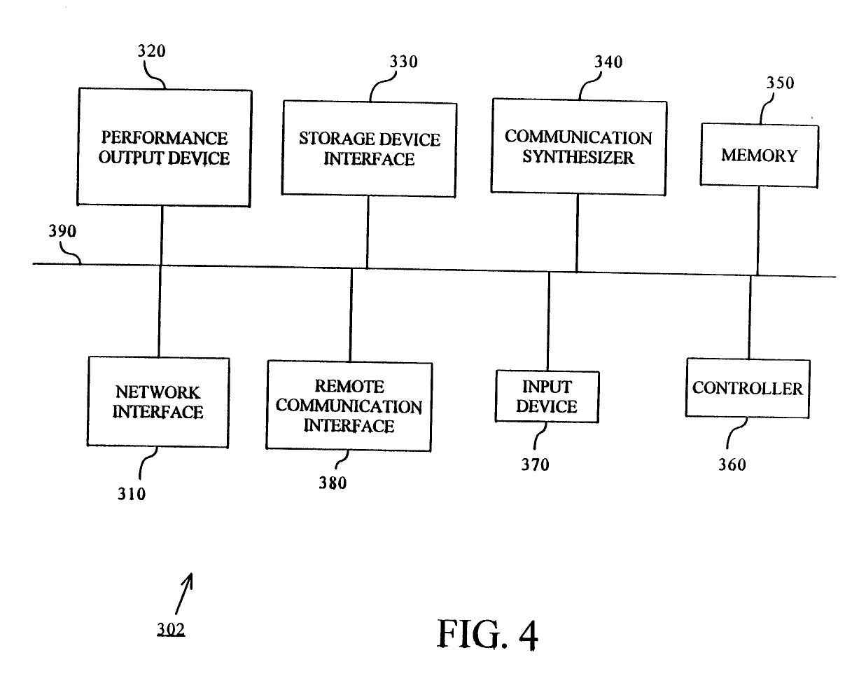

FIG. 4 is an exemplary block diagram of the performance reproduction device 302. The performance reproduction device 302 may include a network interface 310, a performance output device 320, a storage device interface 330, a communication synthesizer 340, a memory 350, a controller 360, an input device 370 and a remote communication interface 380, all of which are interconnected by a signal bus 390.

The input device 370 may be connected to the signal bus 390 via a wired, wireless or optical link. For example, the input device 370 may be incorporated in a hand-held remote control unit or the like.

The remote communication interface 380 may receive remote commands to perform performance reproduction device functions via a wireless or wired link. If the network 100 is used then the remote communication interface 380 may be combined with the network interface 310.

The network interface 310 may include wired, optical or wireless interfaces such as an antenna, satellite dish or the like for receiving performance information from the network 100. While FIG. 4 shows the performance reproduction device 302 in a bus architecture, other architectures may be used as is well known to one of ordinary skill.

The communication synthesizer 340 may perform audio or video synthesis. For example, if text data of a news broadcast or the like is received from the network 100, the communication synthesizer 340 may, using known or later-developed techniques, generate a spoken reproduction of the news broadcast based on the text data. As another example, when the performance reproduction device 300 is an enhanced television or the like, the communication synthesizer 340 may, using known or later-developed techniques, generate a video of a “virtual weatherman” giving a weather report based on text or other data received from the network 100. The communication synthesizer 340 may include an input device that allows a user to select synthesis options. For example, the user could select desired voice characteristics, a favorite newscaster, actor, or actress, or sign language or close-captioning options to be used in generating the pseudo-live performance. Language translation functions may also be provided in the communication synthesizer 340 so that, for example, a user may “tune in” to an English radio station, but hear the performance in Spanish.

The memory 350 may store data such as programs or control parameters and may also serve as a buffer for information received from the network 100. For example, the memory 350 may store information transferred from, or information to be transferred to, the storage device 402 or buffer information received from the network 100. In fact, the memory 350 may be a part of the storage device 400 or vice versa. The controller 360 controls where the information received from the network 100 is stored.

When the performance information is received from the network 100 via the network interface 310, the controller 360 may cause the performance information to be sent directly to the performance output device 320 (e.g., television screen or radio speaker) or stored in the memory 350 for later output based on commands either received from the network 100 or generated by a program in the memory, for example. The program may function based on a profile that indicates user preferences. When a command is received from the network 100 via the network interface 310, the controller 360 may, based upon the command, retrieve information from the memory 350 or from the storage device 402 via the storage device interface 330 for output to the performance output device 320 for the pseudo-live performance.

The controller 360 may cause performance information received from the network 100 to be stored in the storage device 402 for subsequent reproduction. The controller 360 may even send performance information to the performance output device 320 and the storage device 402 at the same time. For example, when the performance information is a newly released song or movie, it may be output via a speaker or television monitor while being transmitted from a transmitting station, and simultaneously recorded in the storage device 402 for subsequent reproduction.

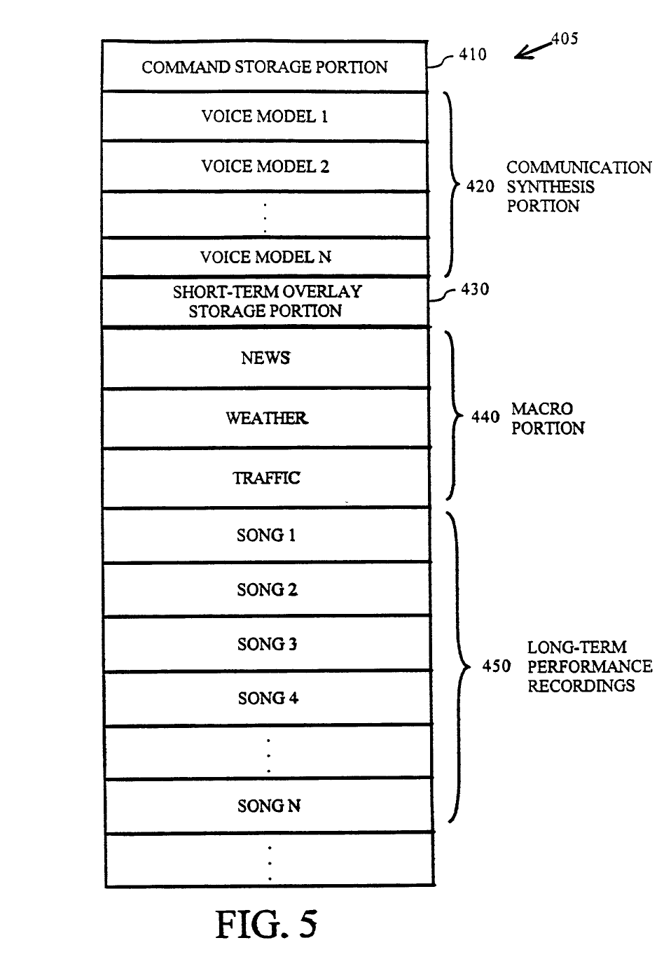

FIG. 5 shows an exemplary diagram of the storage device contents 405. The storage device contents 405 may include a command storage portion 410, a communication synthesis portion 420 including voice models and/or other communication synthesis data, a short-term overlay storage 430, a macro portion 440 including news, weather and traffic storage portions, for example, and long-term performance recordings 450 such as songs 1-N where N is a positive integer.

The command storage portion 410 may store individual commands and/or command sequences, such as are described in detail below. Furthermore, the command portion may contain pre-stored commands or command sequences, and/or commands or command sequences that have been transmitted over the network 100.

Commands may include performance commands, housekeeping commands, programming commands (i.e., software programs as compared to “radio” programs, for example) or the like. Performance commands may be, for example, commands for reproducing information from specified locations of the storage device 402. Examples of performance commands are given in the following Table 1.

TABLE 1

| | Command | | | | |
|---|---|---|---|---|---|
| 1 | Code | Time | Duration | Pointer | — |
| 2 | Play 1 | Immediate | 5 min. | attached | — |
| 3 | Play 2 | 12:00 p.m. | 2 min. | file id | — |
| 4 | Repeat daily | 12:02 p.m. | <5 min. | macro id | — |
| . | . | . | . | . | . |
| . | . | . | . | . | . |
| . | . | . | . | . | . |

Row 1 of Table 1 shows that a performance command may include a command code, time, duration, and pointer parameters, for example. Other parameters may also be included in a command as indicated by the dashes. Rows 2-4 show examples of possible commands. Row 2 shows a “Play 1” command code that instructs the performance reproduction device 302 to output performance information appended to the command beginning immediately and continuing for five minutes. The Play 1 command code may also include a pointer to a file in the storage device 402. For example, a special value of “FFFFₓ” may indicate “attached” and any other value may indicate a pointer in the storage device 402.

Row 3 shows a “Play 2” command code that instructs the performance reproduction device 302 to reproduce a stored information located at file id beginning at 12:00 p.m. and continuing for 2 minutes. Row 4 shows a “Repeat daily” command code that instructs the performance reproduction device 302 to generate a performance using a macro at macro id beginning at 12:00 p.m. and continuing for less than five minutes. A macro may be a predetermined sequence of commands or special set of program instructions to perform a sequence of functions. The “Repeat daily” command may, for example, execute a macro that reproduces a news broadcast using the above-described communication synthesizer 340.

In the above-described performance commands, the “duration” may correspond exactly to the duration of the information to be reproduced. Alternatively, the performance reproduction device 302 may, for example, insert predetermined filler material before and/or after the stored information, and/or increase or decrease the playback speed (e.g., by evenly distributing or removing short intervals of silence, or actually increasing or decreasing the time used for playback) in order to fill the instructed duration. For example, if the indicated “duration” is five minutes, but the stored information only requires four minutes and fifty-three seconds to reproduce, the performance reproduction device may insert a six-second message, such as “You are listening to station 98.7, WMZQ”, and a one-second interval of silence. Alternatively, rather than containing a “duration” designation, a command may contain instructions to begin a performance reproduction after a previous command has been executed, without reference to a particular time of day.

Housekeeping commands may include, for example, commands for manipulating or reorganizing information in the storage device 402. Some examples of housekeeping commands are given in the following Table 2.

TABLE 2

| | Command | | | Pointer or | |
|---|---|---|---|---|---|
| 1 | Code | Type | Size | Name | — |
| 2 | Load | movie | 33 Gigabytes | attached | — |
| 3 | Delete | traffic | 11 Megabytes | file id | — |
| 4 | Overlay | weather | 18 Megabytes | file id | |
| 5 | Change | voice model | 18 Megabytes | file id | — |
| . | . | . | . | . | . |
| . | . | . | . | . | . |
| . | . | . | . | . | . |

Row 1 of Table 2 shows that a performance command may include a command code and type, size, and pointer or name parameters, for example. Additional or alternative parameters may also be included in a command. Rows 2-5 show examples of housekeeping commands. Row 2 shows a “Load” command that loads an attached (i.e., being transmitted via the network 100) 33 Gigabyte movie to a specified location of the storage device 400. Row 3 shows a “Delete” command that instructs that stored traffic information is to be deleted. Row 4 shows an “Overlay” command that instructs that stored weather information is to be replaced with new information. Row 5 shows a “Change” command that changes a voice model of a particular anchor person due to an actual change in the voice of the anchor person (e.g., if the anchor person caught a cold).

Programming commands (software programs) may include, for example, software instructions for controlling the performance reproduction device 302 to generate pseudo-live performance. For example, there may be programming commands such as “case statement”, “loop”, “if-then-else” and/or the like. Such well known commands may be used to create macros or complete program productions based on information received over the network 100 and/or information retrieved from the storage device 402.

The communication synthesis portion 420 of the storage device contents may contain voice models, image models and/or the like that the performance reproduction device 302 accesses to generate a synthesized performance based on text data or the like. For example, voice model 1 may be a generic male voice model, voice model 2 a generic female voice model, voice model 3 a voice model of a known radio or television personality, voice model 4 a voice model of a user's grandfather, and so forth.

The short-term overlay storage portion 430 may provide a storage location for temporary information, such as special announcements, advertisements, and/or the like, which will be subsequently replaced with fresh information. Information stored in the short-term overlay storage portion 430 may be in the form of text data that is used, in conjunction with information from the above-described communication synthesis portion 420, to generate synthesized performance.

The macro portion 440 may contain separate sections for news, weather and traffic, for example, and may be updated as appropriate through the network 100 via load commands. The news, weather and traffic sections may be used like the short-term overlay storage 430 described above, storing information that will subsequently be replaced, and may store information in the form of text data that will be used, in conjunction with information from the above-described communication synthesis portion 420, to generate synthesized performance. Furthermore, the news, weather and/or traffic sections may contain standard weather report recordings and/or text data segments, such as “Today will be partly cloudy,” “There is a 40% chance of rain,” “Today's high temperature will be in the 80's,” and so forth. In this case, rather than transmitting entire weather reports via the network 100, macro commands may be transmitted that activate reproduction of one or more appropriate standard recordings or text data segments that have been pre-stored in the macro portion 440. For example, a macro may be defined in which the three above-mentioned phrases are combined. When a command is received corresponding to this macro, the performance reproduction device outputs a synthesized or pre-recorded performance that says, “Today will be partly cloudy. There is a 40% chance of rain. Today's high temperature will be in the 80's.”

The long-term performance recordings portion 450 may include song storage sections Song 1-Song N (when the performance reproduction device 302 is an enhanced radio), movie storage sections (when the reproduction device is an enhanced television), and/or other types of performance recordings, for example. Each song storage section, movie storage section or the like may contain a pre-stored song or movie or the like, or may include empty sections, thus providing a space for a song or movie to be stored in the future. Parts of the long-term performance recordings portion 450 may be read only, while other parts may be overwritten by other information.

Each item of information in the long-term performance recordings portion 450, such as each song or movie, may be tagged with as much additional information as desired. For example, country music songs may be tagged with a “country” tag, songs about girls named “Charlene” may be appropriately tagged, and/or tags may be provided that cause the name of the song, the recording artist, and/or the like to appear on a display while the song is being reproduced. These tags may, for example, be accessed by the above-described commands. For example, a command may instruct that songs having a “Garth Brooks” tag be played in succession.

It should be appreciated that there may be various other portions included in the storage device 402, such as an advertisement portion, a commercial portion and/or the like. It should also be appreciated that the storage device may contain fewer storage portions than are shown in FIG. 5. For example, the storage device may contain only the long-term performance recordings portion 450.

The performance reproduction device 304 may have a structure similar to that of the performance reproduction device 302 described above, and the storage device 404 may be similar to the storage device 404 described above.

The commands described above may be transmitted and/or stored as part of larger command sequences. This allows an extended period of pseudo-live performance generation to be programmed in advance. Exemplary command sequences are described below.

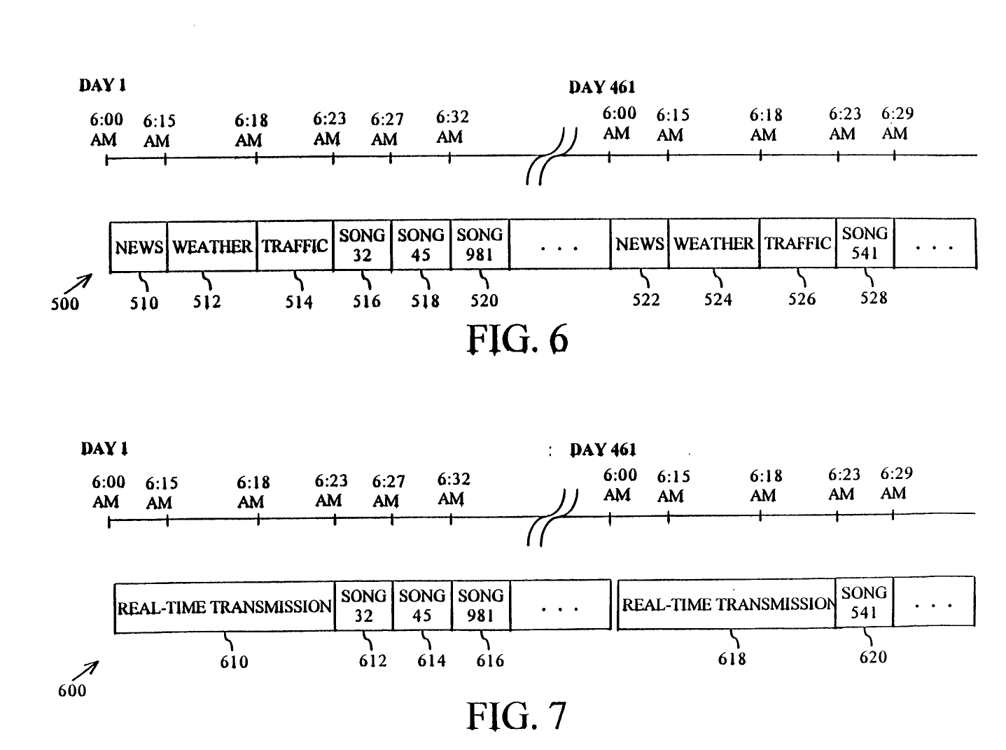

FIG. 6 is a diagram of one exemplary command sequence 500. The command sequence 500 includes “news” commands 510 and 522, “weather” commands 512 and 524, “traffic” commands 514 and 526, and “song” commands 516, 518, 520 and 528. In this example, at 6:00 AM on Day 1 of programming, the “news” command 510 causes news information to be reproduced from the “news” storage portion of the macro portion 440 (FIG. 5) of the storage device 402. Next, at 6:15 AM, the “weather” command 512 causes weather information to be reproduced from the “weather” storage portion of the macro portion 440 of the storage device 402. At 6:18 AM, the “traffic” command 514 causes traffic information to be reproduced from the “traffic” storage portion of the macro portion 440 of the storage device 402. Then “song” commands 516, 518 and 520 cause song 32, song 45 and song 981 to be reproduced from the long-term performance recordings portion 450 of the storage device 402 at 6:23 AM, 6:27 AM and 6:32 AM, respectively.

The command sequence 500 may be as long as desired, and may include commands for reproducing information that has not yet been stored. For example, the command sequence 500 includes the “news” command 522 for reproducing news information from the storage device 402 on Day 461 of programming, but it is obvious that, at the time the command sequence 500 is sent, the news for Day 461 is not yet known. Therefore, the “news” storage portion of the macro portion 440 of the storage device 400 will be updated with fresh news information for Day 461 at some time prior to 6:00 AM on Day 461, for example, and then this updated information will be reproduced at 6:00 AM on Day 461 based on the previously transmitted command sequence;

Furthermore, the command sequence 500 itself may be updated or interrupted. For example, according to the command sequence 500, song 541 is scheduled to be reproduced at 6:23 AM on Day 461. However, if it is desired to transmit an urgent and/or unexpected public announcement at 6:20 AM, for example, the public announcement may be transmitted and stored in the storage device 402 and a new command corresponding to the public announcement may be transmitted to replace the “song” command 528. Then, at 6:23 AM, rather than reproducing song 541, as previously scheduled, the performance reproduction device 302 will reproduce the public announcement. Alternatively, at 6:20 AM, the public announcement may, as a real-time transmission, interrupt the traffic information that is currently being reproduced based on the “traffic” command 526.

FIG. 7 is a diagram of another exemplary command sequence 600. The command sequence 600 is similar to the command sequence 500, except that the “news”, “weather” and “traffic” commands are replaced with “real-time transmission” blocks 610 and 618. In this case, rather than pre-storing news, weather and traffic information in the storage device 402, the news, weather and traffic information, and/or any other desired information, is transmitted in real-time to the performance reproduction device 300 during the indicated time blocks.

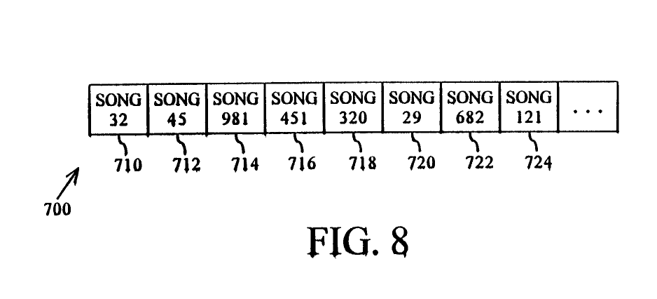

FIG. 8 is a diagram of yet another exemplary command sequence 700. The command sequence 700 is not necessarily time dependent. The command sequence 700 includes “song” commands 710, 712, 714, 716, 720, 722, 724, . . . , which cause songs to be reproduced from the storage device in the order of song 32, song 45, song 981, song 451, song 320, song 29, song 682, song 121, . . . . The order of the songs may be generated randomly, may be determined by a software program (programming commands), or may be selected as desired by one or more persons involved with transmitting or pre-storing the command sequence 700. Furthermore, the command sequence 700 may contain one or more commands corresponding to songs that have not yet been stored in the storage device.

Using the command sequence 700, the performance reproduction device 302 reproduces songs in the instructed order until a signal is received from the network 100. The performance reproduction device 302 treats this receipt of a signal as a command to reproduce performance information received from the network 100. The performance reproduction device 302 then inserts performance information received from the network 100 into the mix of information being reproduced.

In FIGS. 6-8, individual commands are part of larger command sequences. However, it should be appreciated that commands may be transmitted and/or stored individually, if desired or appropriate.

Program sequences may be generated by the reproduction device 302 by using programming commands such as loops, branches, if-then-else statements, and/or case statements as is well known to those skilled in software programming art. Special commands may handle real-time performances or account for unexpected circumstances such as storage failure, etc.

When it is desired to transmit information to the performance reproduction device 302, the performance transmitter 200 may, by keeping track of the time, know when a break, such as a break between songs, will occur and transmit a signal at this break. Alternatively, the performance transmitter 200 may transmit the signal at an arbitrary time, and the performance reproduction device 302 may receive the signal, temporarily store information transmitted from the performance transmitter via the network 100, and reproduce the transmitted information at the next available, or otherwise designated, break. Obviously, if a transmission from the performance transmitter 200 is urgent (e.g., national emergency), information such as a song, for example, that is currently being reproduced by the performance reproduction device 302 may be interrupted.

After the command sequence 700 has been thus interrupted and information received through the network 100 has been reproduced, the performance reproduction device 700 may continue reproducing songs according to the command sequence 700. Alternatively, a new command sequence may be followed.

The performance reproduction device 302 and/or 304 may receive requests via the input device 370 to transmit, receive and/or temporarily hold performance information. For example, the PLPG may provide a pause feature where the user pauses the reproduction of a received performance by the PLPG while buffering a received public broadcast. The PLPG may then respond to a remote command to generate a private transmission of the buffered information so that the user may enjoy the “re-transmitted” public broadcast at another physical location (such as a friend's house) using another PLPG or a conventional transmission receiver tuned to the transmission frequency used by the PLPG.

The PLPG may provide other advantageous features such as separating the received public broadcast information into constituent parts and permitting the user to manipulate the public broadcast information by adding, modifying, replacing or deleting various parts to generate a new performance. For example, the user may anticipate the transmission of a favorite performance and instruct the PLPG to filter out a lead voice portion so that the user may perform the lead voice together with the remaining portions of the performance. This new performance may be transmitted by the PLPG to the user's friends, for example.

Other performance alterations may be possible. For example, a user may add commentary to a performance; record multiple performances, or portions thereof, and compile them into a new performance (e.g., record multiple songs and compile them into a “favorite songs” list); or replace portions of one performance with stored and/or synthesized content (e.g., replace one singer's voice with another).

When a user located at the performance reproduction device 304 desires to request performance information from the performance reproduction device 302, the user inputs a request via the input device (not shown) of the performance reproduction device 304. This request could, for example, be a “resume” command, as described in more detail below, a request for specific performance information, such as information for reproducing a specific movie, or a request for performance information that has been modified by another user and made available via the performance reproduction device 302. The request is transmitted to performance reproduction device 302 via a network interface (not shown) or a remote communication interface (not shown) of the performance reproduction device 304, under the control of a controller (not shown), and is received by the performance reproduction device 302 via the network interface 310 or the remote communication interface 380.

If the performance reproduction device 302 can process the request from the performance reproduction device 304 automatically, it does so, under the control of the controller 360, and transmits the requested performance information. If further input is needed, such as input by a user associated with the performance reproduction device 302, the controller 360 may cause a message to be displayed, asking the user for input.

For example, assume that Bill is watching a football game on performance reproduction devices 302, and that Bob wants Bill to re-transmit the game to Bob at the performance reproduction device 304, along with Bill's comments on the game. Bob inputs an appropriate request, and the performance reproduction device 302 displays a message such as “Bill, Bob has requested transmission of the game, and would like your comments on the game”. Bill could then, using a microphone, keyboard or the like provided on the input device 370, input his comments on the game. The controller 370 would then provide appropriate control to combine Bill's comments with the performance information for the football game and transmit the combined information to the performance reproduction device 304.

Responding to some requests requires that stored information be available to the requested receiving party. For example, assume that performance information from the performance transmitter 200 has been received at the performance reproduction device 302, and the performance information includes commands for mixing information stored in the storage device 402. If a user requests that the performance information be transmitted from the performance reproduction device 302 to the performance reproduction device 304, the commands cannot be executed by the performance reproduction device 304 unless corresponding information is stored in the storage device 404. For example, performance information from the performance transmitter 200 may include a command to play the movie “Rocky”, which has previously been stored in the performance reproduction device 302. When the user requests the performance reproduction device 302 to transmit the performance information to the performance reproduction device 304, the performance reproduction device 304 cannot execute the command to play “Rocky” unless “Rocky” has also been pre-stored in the storage device 404.

Therefore, when the request is received by the performance reproduction device 302, the controller 360 determines whether the performance reproduction device 304 has all the necessary information for outputting the instructed performance. This may be done by, for example, sending a query signal to the storage device 404 (either directly or via the performance reproduction device 304) to access index information showing what performances are stored in the storage device 404, or by consulting a log of previous transmissions sent to the storage device 404.

For example, in the above-mentioned “Rocky” example, when the performance reproduction device 302 receives a request to re-transmit the “Rocky” performance information to the performance reproduction device 304, the controller 360 may send a query signal to the performance reproduction device 304 via the remote communication interface 380 or the network interface 310. The query signal asks whether “Rocky” is stored in the storage device 404. In response, the performance reproduction device 304 searches the storage device 404, by searching tag or header information, for example, or by searching a separate index maintained in conjunction with the storage device 404, and determines whether “Rocky” is stored in the storage device 404.

If “Rocky” is stored in the storage device 404, then the performance reproduction device 302 transmits the performance information as requested. If “Rocky” is not stored in the storage device 404, then the performance reproduction device 302 may initiate procedures to obtain “Rocky” from the storage device 402 and transmit it to the storage device 404 and/or the performance reproduction device 304. The controller 360, or another entity elsewhere on the network 100, may determine, by consulting a profile or the like (not shown), whether such a transmission is authorized. For example, if a user at the performance reproduction device 302 wishes to re-transmit “Rocky” to the user's friend at the performance reproduction device 304, payment of a fee may be required before the transmission is authorized. The performance reproduction device 302 may, using the communication synthesizer or the like, perform format conversions when a transmitting device's format does not match a receiving device's format. For example, the performance reproduction device 302 may be a user's enhanced television, and the performance reproduction device 304 may be the user's enhanced car radio. The user may be viewing a performance, such as a football game, at home on the performance reproduction device 302, and need to leave home on an errand. The user wants to continue viewing the football game, and pushes an enhanced “pause” button on the performance reproduction device 302. Pushing the “pause” button causes the performance reproduction device 302 to buffer any performance information for the football game received after that point into the memory 350 or the storage device 402.

The user then goes to the car, turns on the performance reproduction device 304 (radio), and pushes a “resume” button, and a “resume” request is transmitted to the performance reproduction device 302. The user may also need to enter a code at this time. This code could, for example, be unique to the performance reproduction device 302. For example, each time a pause request is transmitted from the performance reproduction device 302, the code unique to the performance reproduction device 302 would be input to resume the performance. Alternatively, the code could be unique to the request itself. For example, when the user pushes the “pause” button, the performance reproduction device 302 could display a message such as “Your pause request number is XXXXX”. Then, when the user pushes the “resume” button, the user would also enter the appropriate code as part of the “resume” request.

The performance reproduction device 304 also may transmit capability information, or a code or command that allows performance reproduction device 302 to access capability information using a lookup table or the like, which indicates what format is appropriate for the performance reproduction device 304. In this example, the performance reproduction device 304 indicates that it is a radio and can only output audio information.

When the performance reproduction device 302 receives the “resume” request, the controller 360 matches the “resume” request with the previously-received “pause” request. The controller 360 determines that the television format needs to be converted to a radio format, and causes the appropriate format conversion to be performed using the communication synthesizer 340 or the like. The performance reproduction device 302 transmits the re-formatted, buffered performance information to the performance reproduction device 304. Thus, the user can hear the football game on the performance reproduction device 304, beginning from the point at which the “pause” button was pushed on the performance reproduction device 302.

In addition to the video-to-audio conversion described above, other possible examples of format conversion include audio-to-video (using video synthesis), high-resolution-to-low resolution (using a “thinning” process or the like), and low-resolution-to-high-resolution (using an interpolation process or the like). Any other suitable known or later-developed format conversion may also be performed.

It should be appreciated that when a re-transmission request, such as the “pause” request described above, is transmitted from the performance reproduction device 302 or 304, the current performance may continue to be output in addition to being re-transmitted. For example, in the above-described situation, the football game may continue to be output by the performance reproduction device 302 even after the “pause” button is pushed so that the user's family can continue to watch the football game after the user leaves the house.

Several examples of specific operations performed using the above-described network 100, performance transmitter 200, performance reproduction devices 302 and 304, and storage devices 402 and 404 are described below. In a first example, the performance transmitter 200 is a radio station, the performance reproduction device 302 is an enhanced radio, and the storage device 402 has been pre-loaded with a library of songs. A radio announcer speaks into a microphone, which is included in the performance input device 220 of FIG. 2, and says, for example, “Here are the three most-requested songs of this week.” The announcer then pushes one or more buttons, for example, on the command input device 230, and a command signal sequence including a Play 1 command appending the announcer's real-time performance is generated and transmitted to the network 100.

The announcer's voice information announcing “Here are the three most-requested songs of this week” is output through the performance output device 320, corresponding in this case to a radio speaker, based on the Play 1 command. The remaining command signal sequence is executed by retrieving the three songs from the storage device 402 and outputting them to the radio speaker in the order indicated by the command signal sequence.

The radio station may transmit addition program information any time before the reproduction of the songs is completed. For example, the radio announcer may announce, “We will be back with more music after these messages from our sponsors” and then issue commands for reproduction of pre-recorded commercials or the like. The corresponding commands are transmitted to the performance reproduction device 302 prior to the actual performance output time. Thus, the radio station is provided great flexibility in performance production because the time of performance production is not tightly coupled to the time of performance output.

In a second example, the performance transmitter 200 may be a television station, and the performance reproduction device 302 may be an enhanced television set. The user watches a new episode of a weekly program. While the user is watching the new episode, the new episode is simultaneously recorded to the storage device 402. Months later, it is decided to re-run the episode. However, rather than re-transmitting the entire episode, the television station transmits one or more command signals to the enhanced television set, instructing the enhanced television set to retrieve and output the episode from the storage device 402.

In a third example, the performance transmitter 200 is a radio station and the performance reproduction device 302 is an enhanced car radio. At 1:00 AM, the user is asleep at home in Washington, D.C., and is not listening to the car radio. However, the radio station receives world news information from the British Broadcasting Company in Great Britain, and automatically stores this information to the storage device 402, along with one or more commands. Later, at 7:30 AM, while driving to work, the user listens to the car radio. Based on the previously transmitted one or more commands, the car radio retrieves and reproduces the information that was stored earlier that morning beginning at 1:00 AM. In this manner, information may be transferred to the car radio at low network usage times and any time prior to the generation of a performance. Furthermore, from this example it is seen that a real-time radio announcer is not required.

In a fourth example, a user of the performance reproduction device 302 receives performance information from the performance transmitter 200, views the performance, modifies the performance, and then transmits the performance to a user of the performance reproduction device 304. For example, the performance may be a symphony performance, and the user of the performance reproduction device 302 may be an oboe player. The user modifies the performance by playing the oboe (or any other instrument audio input) and overlaying the oboe performance onto the original symphony performance. The user causes the performance reproduction device 302 to transmit the modified performance to the performance reproduction device 304.

In a fifth example, a user of the performance reproduction device 302 is a fan of the famous cellist Yoyo Ma, and listens to and collects performances of the artist as a hobby. The user makes the performances available to other users upon request. Requests from other users may be processed directly by the performance reproduction device 302 or a local server (not shown) or the like. Performance reproduction device 302 may store the performance information temporarily until a request for the information is received, or until a certain amount of time (e.g., one month) has elapsed. Alternatively, the performance reproduction device 302 may store the received performance information permanently and act as an archive. The other users may learn the existence of the of information by word-of-mouth or by using a search engine or the like.

In a sixth example, a user has created an “all-star cast” version of a movie by inserting his or her favorite actors and actresses into received movie using the communication synthesizer 340 of FIG. 4 and the communication synthesis portion 420 of the storage device 402 (FIG. 5). The user then makes this novel version of the movie available to other users upon request using one or more of the techniques described above.

In a seventh example, a user is watching a movie at the performance reproduction device 302, which is in a hotel room, but must leave the hotel room before the movie is over. The user pushes a “pause” button, goes home, and pushes a “resume” button on the performance reproduction device 304. The user may then finish viewing the movie.

In an eighth example, a user listens to music on the performance reproduction device 302 over some period of time, and decides to send his or her favorite songs to a friend at the performance reproduction device 304. The songs are already recorded in the storage device 404, so the user transmits only the commands for accessing the songs. That is, the user transmits what is effectively a “play list” of the desired songs.

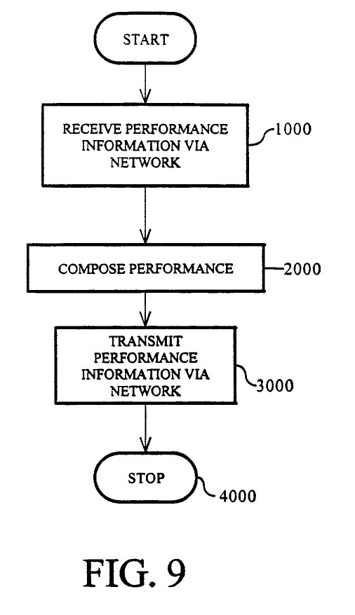

FIG. 9 is a flowchart of an exemplary method for receiving and re-transmitting a performance. This process may be performed by the performance reproduction device 302 or 304 of FIG. 1, for example. In step 1000, the process receives performance information via the network 100 and goes to step 2000. In step 2000, the process composes a performance using the performance information received in step 1000. Composing the performance may or may not include outputting the performance. The process then goes to step 3000.

In step 3000, the process transmits performance information via the network 100. This transmission may be directly to a performance reproduction device 302 or 304, or may be via the performance re-transmission processor 800. The process then goes to step 400 and ends.

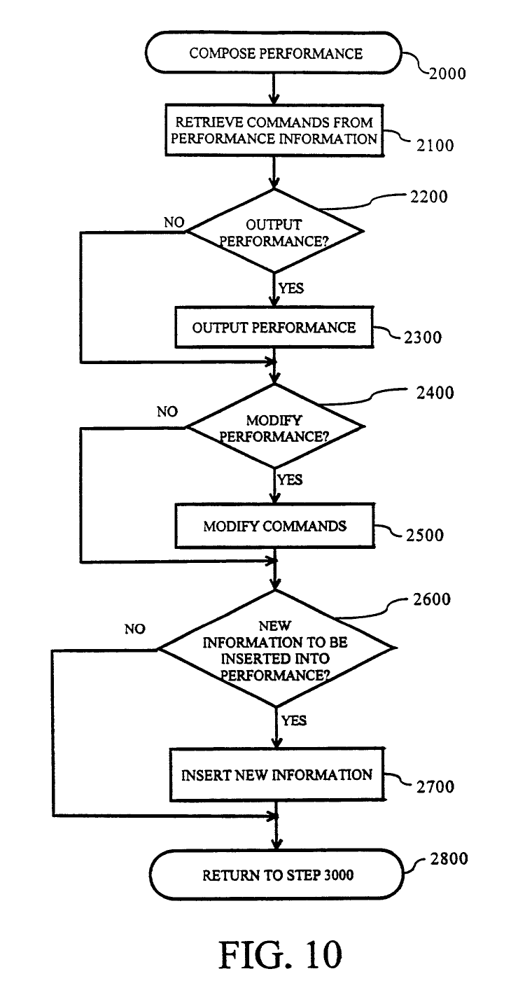

FIG. 10 is a flowchart of an exemplary method for the composing a performance step 2000 of FIG. 10. In step 2100, the process retrieves one or more commands from the performance information received in step 1000 of FIG. 9. The process then goes to step 2200 and determines whether a performance is to be output by, for example, the performance reproduction device 302. If a performance is to be output, the process continues to step 2300. Otherwise, the process goes to step 2400.

In step 2300, the process outputs the performance, and then continues to step 2400. In step 2400, the process determines whether the performance is to be modified. If the performance is to be modified, the process continues to step 2500. Otherwise, the process goes to step 2600. In step 2500, the process modifies the commands retrieved in step 2100. The modification may include adding to and/or subtracting from the retrieved commands. The process then goes to step 2600.

In step 2600, the process determines whether new information is to be inserted into the performance. For example, if the commands have been modified to instruct reproduction of new information provided by a user of the performance reproduction device 302, such as in the above-described oboe recording example, then this new information will need to be included along with the modified commands, because it might not be available elsewhere.

If new information is to be inserted, the process continues to step 2700. Otherwise, the process goes to step 2800. In step 2700, the process inserts the new information, then goes to step 2800. Finally, in step 2800, the process returns to step 3000 of FIG. 10.

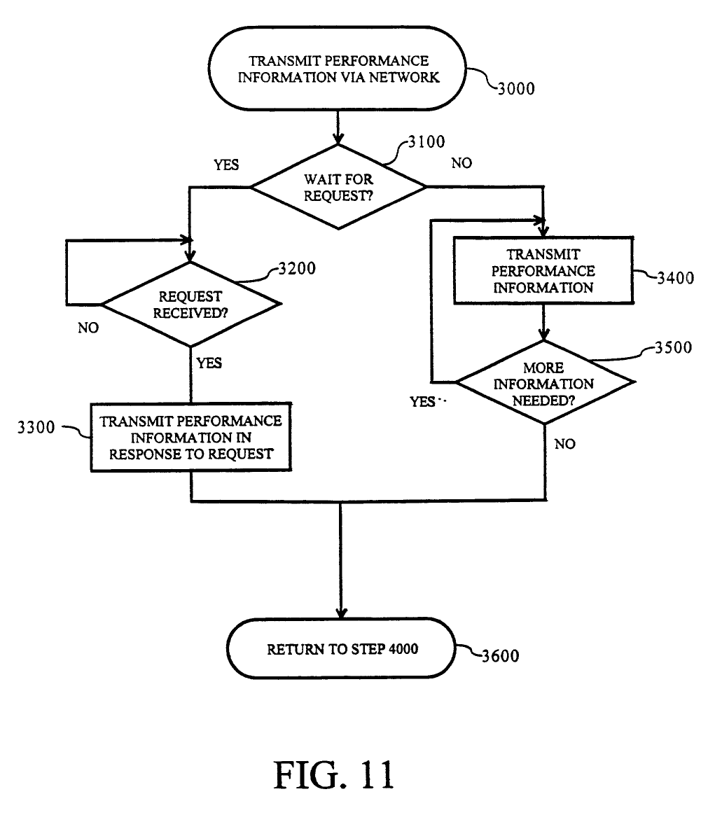

FIG. 11 is a flowchart of an exemplary method for the re-transmitting a performance step 3000 of FIG. 9. In step 3100, the process determines whether to wait for a request to transmit performance information. In other words, it is determined whether performance information is to be made available for later retrieval upon request from a performance reproduction device (“YES”), or whether the performance information is to be immediately transferred to a specified location without waiting for a request (“NO”). If a request is to be awaited, the process goes to step 3200. Otherwise, the process goes to step 3400.

In step 3200, the process determines whether a request has been received. Step 3200 is repeated until a request is received. Then the process continues to step 3300, transmits performance information in response to the request, and then goes to step 3600.

In step 3400, the process transmits performance information, and then goes to step 3500. In step 3500, the process determines whether more information is needed. This determination may, for example, be made when a request for more information is received. For example, the process may transmit only commands in step 3400, but it may subsequently be determined that the receiving-side performance reproduction device does not have the necessary stored information to execute the commands. In this case, “YES” would be determined in step 3500, the process would return to step 3400, and the necessary additional performance information would be transmitted.

When all the necessary performance information has been transmitted, the process goes to step 3600 and returns to step 4000 of FIG. 9.

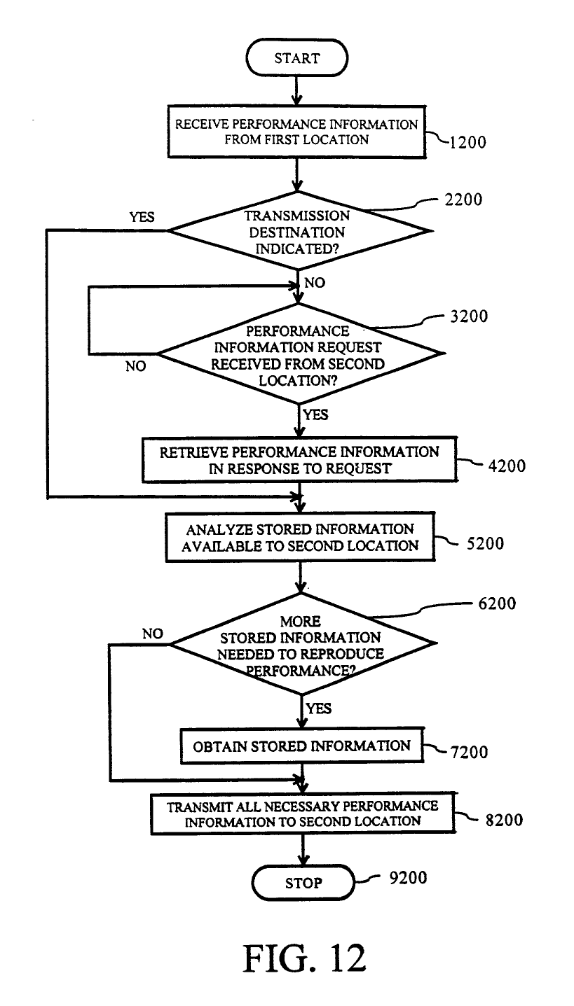

FIG. 12 is a flowchart of an exemplary method for processing a performance re-transmission request. In step 1200, the process receives performance information from a first location. The process then goes to step 2200 and determines whether a transmission destination, i.e., a second location, is indicated by commands included with the performance information. If a transmission destination is indicated, the process goes to step 5200. If the received performance information does not include a designation of a transmission destination, the process continues to step 3200.

In step 3200, the process determines whether a performance information request has been received from a second location. Step 3200 is repeated until a request is received. The process then continues to step 4200, retrieves the performance information in response to the request, and then continues to step 5200.

In step 5200, the process analyzes the stored information available to the second location. The process then proceeds to step 6200 and, using information from the analysis of step 5200, determines whether more information is needed by the second location to reproduce a performance. In other words, for example, the process determines whether the second location has access to all performance information designated by commands included in the performance information. If more stored information is needed, the process continues to step 7200. Otherwise, the process goes to step 8200.

In step 7200, the process obtains any necessary stored information, and then goes to step 8200. In step 8200, the process transmits all necessary performance information to the second location. The process then goes to step 9200 and ends.

The performance transmitter 200 and the performance reproduction devices 302 and 304 can each be implemented on a general purpose or special purpose computer, a programmed microprocessor or microcontroller and peripheral integrated circuit elements, an application specific integrated circuit (ASIC) or other integrated or non-integrated circuit, a programmable logic device such as a PLD, PLA, FPGA or PAL, or the like, or any appropriate combination thereof. In general, any device capable of implementing at least some portions of the flowcharts shown in FIGS. 3 and 9-12 can be used to implement the performance transmitter 200, the performance reproduction devices 302 and/or the performance reproduction device 304.

Using the above-described embodiments, “pseudo-live” transmission may be performed in which, although the performance reproduced by a performance reproduction device has the appearance of a “fully live” transmission, part of the performance has actually been stored in or near the performance reproduction device in advance. The user may not even realize that this is the case.

Additionally, the user may re-transmit performances to other locations, with or without modification of performance content. Thus, great flexibility and variety is provided to a network in offering services to subscribers.

While the invention has been described in conjunction with the specific embodiments described above, many equivalent alternatives, modifications and variations will become apparent to those skilled in the art once given this disclosure. For example, the performance transmitter 200 and the performance reproduction device 302 are shown in FIGS. 2 and 4 using bus architecture when any other architecture may be used as is well known in the art. Accordingly, the exemplary embodiments of the invention as set forth above are considered to be illustrative and not limiting. Various changes to the described embodiments may be made without departing from the spirit and scope of the invention.

What is claimed is:

1. A method for transmitting a performance via a network, comprising:
receiving performance information including one or more mixing commands via the network;
composing a performance by mixing stored information based on the one or more mixing commands; and
transmitting one or more portions of the performance.

2. The method of claim 1, wherein the transmitting one or more portions of the performance comprises transmitting one or more portions of the performance information received via the network.

3. The method of claim 1, wherein the transmitting one or more portions of performance information comprises transmitting new information not included in the performance information received via the network.

4. The method of claim 1, wherein the composing the performance comprises:
composing a first performance based on the one or more mixing commands;
separating the first performance into performance components; and
modifying one or more of the performance components to create a second performance; and
wherein the transmitting the one or more portions of the performance comprises transmitting one or more portions of the second performance.

5. The method of claim 4, wherein the modifying the one or more performance components comprises one or more of deleting a performance component and replacing a performance component.

6. The method of claim 1, further comprising adding a performance component to the performance prior to transmitting the one or more portions of the received performance information.

7. The method of claim 1, further comprising:
buffering the received performance information; and
receiving a request for transmission of the performance;
wherein the transmitting the one or more portions of performance is performed in response to the request for transmission of the performance.

8. The method of claim 7, further comprising:
receiving a pause request;
wherein the buffering the received performance information is performed in response to the pause request.

9. A method for transmitting a performance via a network, comprising:
receiving performance information including one or more mixing commands via the network;
composing a first performance based on the one or more mixing commands;
separating the first performance into performance components; and
modifying one or more of the performance components to create a second performance; and
composing a performance by mixing stored information based on the one or more mixing commands; and
transmitting one or more portions of the second performance.

10. A method for transmitting a performance via a network, comprising:
receiving performance information including one or more mixing commands via the network;
composing a performance by mixing stored information based on the one or more mixing commands;
adding a performance component to the performance prior to transmitting the one or more portions of the received performance information; and
transmitting one or more portions of the performance, including the modified one or more performance components.

11. A method for transmitting a performance via a network, comprising:
receiving performance information including one or more mixing commands via the network;
composing a performance by mixing stored information based on the one or more mixing commands;
buffering the received performance information;
receiving a request for transmission of the performance; and
transmitting the one or more portions of performance in response to the request for transmission of the performance.

12. A performance transmission device, comprising:
a receiver that receives performance information including one or more mixing commands via a network;
a controller that composes a performance by mixing stored information based on the one or more mixing commands; and
a transmitter that transmits one or more portions of the performance.

13. The performance transmission device of claim 12, wherein the transmitter transmits one or more portions of the performance information received via the network.

14. The performance transmission device of claim 12, wherein the transmitter transmits new information not included in the performance information received via the network.

15. The performance transmission device of claim 12, wherein the controller composes a first performance based on the one or more mixing commands; further comprising:
a performance modification system which, based on user input,
separates the first performance into performance components, and
modifies one or more of the performance components to create a second performance;
wherein the transmitter transmits one or more portions of the second performance.

16. The performance transmission device of claim 15, wherein the performance modification system performs one or more of deleting a performance component and replacing a performance component.

17. The performance transmission device of claim 12, further comprising a performance modification system which, based on user input, adds a performance component to the performance prior to transmission of the one or more portions of the received performance information.

18. The performance transmission device of claim 12, further comprising:
a memory that buffers the received performance information;
wherein the controller receives a request for transmission of the performance and causes the transmitter to transmit the one or more portions of performance in response to the request for transmission of the performance.

19. The performance transmission device of claim 18, wherein the controller receives a pause request, and causes the memory to buffer the received performance information in response to the pause request.

20. A performance transmission device, comprising:
a receiver that receives performance information including one or more mixing commands via a network;
a controller that composes a first performance by mixing stored information based on the one or more mixing commands;
a modification system which, based on user input, separates the first performance into performance components and modifies one or more of the performance components to create a second performance;
a transmitter that transmits one or more portions of the second performance.

21. A performance transmission device, comprising:
a receiver that receives performance information including one or more mixing commands via a network;
a controller that composes a first performance by mixing stored information based on the one or more mixing commands;
a modification system which, based on user input, adds a performance component to the performance; and
a transmitter that transmits one or more portions of the performance, including the performance component added by the modification system.

22. A performance transmission device, comprising:
a receiver that receives performance information including one or more mixing commands via a network;
a controller that composes a performance by mixing stored information based on the one or more mixing commands; and
a memory that buffers the received performance information;
wherein the controller receives a request for transmission of the performance and causes the transmitter to transmit the one or more portions of performance via a transmitter in response to the request for transmission of the performance.
